(19) United States
(12) Patent Application Publication
(10) Pub. No.: US 2014/0365179 A1
(43) Pub. Date: Dec. 11, 2014

(54) Method and Apparatus for Detecting and Identifying Faults in a Process

(71) Applicants: YPF Sociedad Anonima, Captial Federal (AR); Consejo Nacional de Investigaciones Cientificas Y Tecnicas (Conicet), Capital Federal (AR)

(72) Inventors: Gabriel Ignacio HOROWITZ, Capital Federal (AR); Miryan CASSANELLO, Capital Federal (AR); Mauricio MAESTRI, Buenos Aires (AR)

(21) Appl. No.: 14/302,143

(22) Filed: Jun. 11, 2014

(30) Foreign Application Priority Data
Jun. 11, 2013 (AR) 20130102056

(51) Int. Cl. G05B 23/02

(52) U.S. Cl. CPC G05B 23/0245; G05B 23/0205
USPC 702/185

(57) ABSTRACT

A method and apparatus is provided for detecting and identifying faults in a process having a set of sensors, each of which produces an associated sensor output signal. The method and apparatus extracts the qualitative trend of each variable after detecting an abnormal situation. The set of variable trends constitutes the fault signature which can be compared to a previously generated signature database.

### TECHNICAL FIELD

The present application relates generally to decision support systems for process monitoring and more particularly to the automatic detection, identification and diagnosis of faults in a process.

### BACKGROUND ART

Process abnormalities and its management have an enormous impact in the process industry. As an example, in 1995, the cost of abnormal events in the US petrochemical industry was estimated in ten billion dollars.

The availability of process data in digital form, not only online, but also stored as historical trends for every measured variable, has driven the development of methods and apparatus that support the diagnosis of process faults. Examples of these methods and apparatus can be found in U.S. Pat. No. 6,298,454, U.S. Pat. No. 6,356,857, U.S. Pat. No. 6,615,090, U.S. Pat. No. 7,421,351, U.S. Pat. No. 7,451,003, AR 063876 B1 and AR 071423 A1.

Many of these methods are based on correlations among variables and the brake of them during failures to detect, identify, and diagnose process abnormalities. When the degree of instrumentation is low, the measured variables are usually less correlated, and the methods based on correlations are no longer suited for monitoring the process. An example of such kind of processes is oil production for which their geographical dispersion increases the communication costs and the oil well depth increases the cost of placing downhole instruments.

Variable trend analysis is particularly appropriate for processes with a low level of instrumentation because it is not based on correlation among variables. This method extracts the qualitative trend of each variable after detecting an abnormal situation. The set of variable trends constitutes the fault signature which can be compared to a previously generated signature database. A review of some available methods for qualitative trend analysis can be found in Maurya et al. (Fault diagnosis using dynamic trend analysis: A review and recent developments, Engineering Applications of Artificial Intelligence, 20, 133-146, (2007)). The methods described in this review take into account not only the first derivative of the trend but also the second derivative, adding complexity that is not always suitable for poorly instrumented processes.

S. Charbonier et al. (A self-tuning adaptive trend extraction method for process monitoring and diagnosis, Journal of Process Control 22, 1127-1138, (2012)) reviewed trend extraction methods than only have first order derivatives. As the authors mention in their paper, most of them require tuning one or more parameters.

### SUMMARY OF THE INVENTION

The present application provides a method and apparatus to detect and diagnose faults in a process. The proposed method includes two stages: the detection and the identification of the failure. The first step includes determination of whether the process is in an anomalous state or not, without identifying the fault. Any multivariate fault detection method can be used to perform this first step. A list of available methods can be found in Venkatasubramanian et al. (V. Venkatasubramanian, R. Rengaswamy, S. N. Kavuri, K. Yin: A review of process fault detection and diagnosis Part III: Process history based methods. Computers and Chemical Engineering 27, 327-346, (2003).

After detecting an anomalous situation, the diagnostic step begins. This step is performed by comparing the trends of change of measured variables, which characterize the current state of the process, with a previously generated library of fault signatures. In this library, each failure is described by the direction of change of all the measured variables. There are three possible states for direction change: a state in which the variable increases significantly due to the failure (described as +1); a state in which the variable decreases significantly due to the failure (described as −1); and a state in which the variable does not change significantly because of the failure (described as 0).

Therefore, each fault is described as a vector that assigns to each variable one of the three possible states. This vector can be calculated as proposed by Maestri et al. (Automatic Qualitative Trend Simulation method for diagnosing faults in industrial processes. Computers & Chemical Engineering, 64, 55-62, (2014)), or obtained from expert knowledge.

The likelihood of each fault in the library is obtained from the distance of the vector of variable trends after detecting the fault, to each fault vector in the library. The fault with the higher likelihood is the one selected as the cause of the process fault.

The objective pursued is the detection and diagnosis of faults in sensors or processes. This is achieved with the use of a historical process model for detection and a local model for diagnosis. The latter model is used to determine the trend of each variable after an anomalous situation occurrence. The trend of change of each variable is stored in a trend vector that is compared to the trend vectors corresponding to each of the known faults.

Accordingly, it is an object of the present application to provide a device for diagnosing of anomalous situations in processes, equipment and sensors used to measure and control variables of a process, based on calculation of residuals between measured and calculated values for a plurality of models, the device comprising:

a data storage section that stores data;

a pre-processing section that filters said data;

a modeling section that generates and stores a normal process model for detection and a local process behavior model for diagnosis, the modeling unit allowing determining at what point the device shifts from a steady state prior to a fault to another steady state after the fault;

a residual calculating section that calculates difference between the measured value and a predicted value of variables and determines presence of a fault;

a calculation section that calculates a change trend and establishes a time reference point for comparing a value of each variable before and after the fault, detecting onset of a fault from a local model of system behavior and the time of fault with the process model based on historical data of normal operation, and with two points building two temporal reference points to determine the change trend of each variable;

an analysis section that analyzes, based on a distance between a vector representing current change trends after the fault to vectors corresponding to different known faults, which faults correspond with most probability to the current process situation and determining necessity or communicating an anomalous situation to the process operator; and

a displaying section that displays a process status report.

It is another object of the present application to provide a method for detecting and/or diagnosing faults, which on the basis of calculation of change trends of the measured variables and comparing the change trends to the trends corresponding to a set of faults, a report of status of the process is presented through a communication section, detecting if the process operation is normal or has faults, and diagnosing if a fault occurs after the detection carried out.

In an embodiment of this object of the application, the method for diagnosing anomalous situations in processes, equipment and sensors used to measure and control variables of the process, based on calculation of residuals between measured values and calculated values from a plurality of models, the method comprising:

storing data in a data storage section;

pre-processing said data by filtering the data;

generating and storing by a modeling section a normal process model for detection and a local process behavior model for diagnosis, and allowing determining at what point a steady state prior to the fault is shifted to another steady state after the fault;

detecting presence of a failure using a global model;

calculating a change trend and establishing a time reference point for comparing a value of each variable before and after the fault, detecting onset of the fault from a local model of system behavior and the time of fault with the process model based on historical data of the normal process operation, and with two points building two temporal reference points to determine the change trend of each variable;

analyzing and determining, based on a distance between a vector representing current change trends after the fault to vectors corresponding to different known faults, which faults correspond with most probability to the current process situation and determining necessity or communicating an anomalous situation to the process operator; and

displaying a process status report on a displaying section.

### BRIEF DESCRIPTION OF THE DRAWINGS

FIG. 1 is a block diagram illustrating apparatus and method according to an embodiment.

FIG. 2 illustrates a bad trend extraction when using the historic average as a reference value.

FIG. 3 illustrates an example of a bad trend extraction when the time lag used is too short.

FIG. 4 illustrates times and intervals used to calculate the local model.

### DETAILED DESCRIPTION

In the present application the term steady state is understood as a state of a process with no significant change in its variables. The remaining variance in the variables is attributed to noise of the instruments or the process itself; A process shift is a substantial change that moves its variables away from the steady state; Residual is the difference between the measured value and a predicted value of a variable. The onset of a fault is the time the process begins its movement from the normal to the abnormal situation. The system behavior is represented by a process history based models as described in Venkatasubramanian et al. (V. Venkatasubramanian, R. Rengaswamy, S. N. Kavuri, K. Yin: A review of process fault detection and diagnosis Part III: Process history based methods. Computers and Chemical Engineering 27, 327-346, (2003).

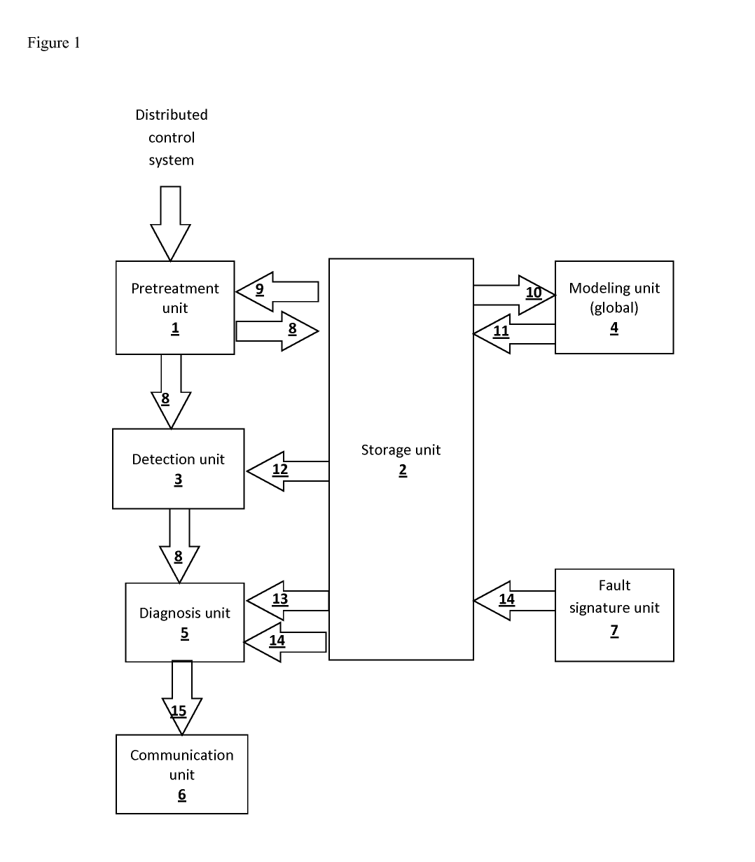

FIG. 1 shows a block diagram of the application. The apparatus receives the process variables measurements in digital form usually from a distributed control system (DCS). The data is filtered using a simple average or a moving average and normalized by subtracting the historic average and dividing by its standard deviation in the pretreatment unit (1). The average and standard deviation (9) are stored in the storage unit (2). The pretreated data (8) is sent to two different units: the storage unit (2) and the detection unit (3).

The storage unit (2) has a set of historical data acquired up to date. A subset of this data, containing data of the process in normal operation (10) is used to calculate a model of the process normal behavior. This task is performed by the global modeling unit (4). There are many different modeling techniques available for this task. Examples of these techniques are: principal component analysis (PCA), Kernel PCA, moving PCA, neural networks, etc. In any case, the model is used to calculate one or more statistics that will be used to assess whether the process is operating in normal or abnormal conditions. The threshold for the statistic together with the global model and the variables historic average and standard deviation (11) calculated by the global modeling unit (4) are stored in the storage unit.

The detection unit (3) uses the global model (12) and the current data vector (8) to determine the current state of the process. Depending on the type of model selected, different statistics are calculated. As an example, when a global PCA model is used, the statistics employed to determine the process state are T2a and SPE.

If an abnormal state is detected, the diagnosis process is triggered. To do this, the diagnosis unit (5) receives the current data vector (8) from the detection unit (3) and, using a local model of the process based on stored data (13), calculates the variable trend pattern characterizing the current process condition. This pattern is compared with the faults signature (14) stored in the storage unit (2) and the likelihood of each stored fault is calculated.

The fault signatures (14) can be manually or automatically generated in the fault signature unit (7) and stored in the storage unit.

The diagnosis unit (5) also sorts the faults based on their likelihood of being the cause of the current abnormal situation and prepares a report containing one or more faults with the highest likelihood. This report (15) is sent to the communication unit (6) that shows the report to the operator trough a display, e-mail or by other means.

In the following paragraphs a detailed description of each unit is given.

Pretreatment Unit

Before using the data, it is filtered by any appropriate method. Moving median or simple averages can be used. The sample interval can vary from 1 millisecond to one year depending on the characteristics of the process. It is also useful to normalize the acquired data. For this purpose, the historic mean μᵢ and the standard deviation σᵢ of each variable “i” are used. Thus, the measured value xmᵢ of variable “i” is converted to the normalized value using the following equation:

$${x}_{i} = ( \frac{{xm}_{i} - {μ}_{i}}{{σ}_{i}} ) \qquad ( 1 )$$

Storage Unit

All the acquired data, model parameters and the fault signature library are stored in the storage unit (2). The storage unit (2) can be magnetic or other type that allows the other units to use the stored data. The storage unit may be a magnetic storage device or other kind of memory that is capable of storing data.

Global Modeling Unit

The global modeling unit (4) takes the historic data set and builds a model that represents the normal operation of the process. As an example, the modeling using principal component analysis (PCA) will be explained.

The correlation matrix R of X can be decomposed in a diagonal matrix L and an orthonormal matrix P

R=PLP^{T} (2)

T is defined as:

T=XP (3)

T and P are the scores and loadings matrices respectively.

In this technique, a matrix X of n samples (rows) and m variables (columns) can be decomposed in the following way:

X=\hat{X}+E (4)

Where \hat{X} and E represent the modeled and not modeled parts of X, which are calculated as indicated in equations 5 and 6.

$$\begin{matrix}\hat{X} = {T}_{a} {P}_{a}^{T} = {\sum }_{i = 1}^{a} {t}_{i} {p}_{i}^{T} & ( 5 ) \\ E = {T}_{e} {P}_{e}^{T} = {\sum }_{i = a + 1}^{m} {t}_{i} {p}_{i}^{T} & ( 6 )\end{matrix}$$

Where m is the number of variables and a is the number of selected principal components.

Pₐ is formed by the first a vectors (i.e. columns) of P. They are associated with the a highest eigenvalues of R. Tₐ is the matrix formed with the first a columns of T. Tₑ and Pₑ are matrices formed with the last m-a columns of T and P, respectively. The number of principal values used to model can be selected using different criteria. In this example the criteria is the value that explains the 95% of the correlation among variables.

P is the model that is stored in the storage unit together with the number of principal components, the principal values (i.e. the diagonal matrix L) and the historical mean and standard deviation.

Detection Unit

After receiving a new measurement vector, the same procedure shown in equations 3, 5 and 6 is applied to it. Two different statistics can be computed for this new measurement considering the first a principal components:

The SSPE (Sum of Squared Predicted Error) that indicates the deviation of the present situation from the model, defined as:

$$SumSPE = {\sum }_{i = 1}^{m} {E}_{i}^{2} \qquad ( 7 )$$

The out of range error, calculated as the Hotelling distance in the model hyperplane. As explained by Simoglou et al. (Multivariate statistical process control for an industrial fluidized-bed reactor. Control Engineering Practice, 8, 893-909, (2000)), it is calculated as:

$${T}_{a}^{2} = {\sum }_{i = 1}^{a} \frac{{t}_{i}^{2}}{{λ}_{i}} \qquad ( 8 )$$

Where S is a diagonal matrix with the covariance of the scores T of the PCA model of X. S⁻¹ is conformed by the k highest principal values of the covariance matrix of X arranged in a diagonal matrix.

When any of these errors trespasses its normal thresholds an abnormal situation is detected. The thresholds can be calculated as described by MacGregor et al. (Process monitoring and diagnosis by multiblock PLS methods. AIChE Journal, Vol. 40, No. 5, 826-838, (1994)) and Lee et al. (Nonlinear process monitoring using kernel principal component analysis. Chemical Engineering Science 59, 223-234, (2004)) and stored in the storage unit (2).

Diagnosis Unit

After detecting an anomalous situation, the diagnostic step begins. This step is performed by comparing the trends of change of measured variables, which characterize the current state of the process, with a previously generated library of fault signatures. In this library, each failure is described by the direction of change of the measured variables. There are three possible states for direction change: a state in which the variable increases significantly due to the failure (described as +1); a state in which the variable decreases significantly due to the failure (described as −1); and a state in which the variable does not change significantly because of the failure (described as 0).

Therefore, each fault is described as a vector that assigns to each variable one of the three possible values. This vector can be automatically calculated as proposed by Maestri et al. (Automatic Qualitative Trend Simulation method for diagnosing faults in industrial processes. Computers & Chemical Engineering, 64, 55-62, (2014)), or obtained from expert knowledge. For example, in the case of process with 8 measured variables an a fault that leaves the first two variables with no significant change the third with as significant increase and the remaining variables with a significant decrease, the vector describing this failure would be as the one shown in Table 1.

TABLE 1
Vector representing a fault

| Variable | Variable | Variable | Variable | Variable | Variable | Variable | Variable |
|---|---|---|---|---|---|---|---|
| 1 | 2 | 3 | 4 | 5 | 6 | 7 | 8 |
| 0 | 0 | 1 | −1 | −1 | −1 | −1 | −1 |

The identification step begins by obtaining the direction of change of each variable to get the fault trend pattern for comparing it with the ones stored in the library. The matching degree indicates the likelihood for each fault in the library to explain the detected abnormal situation.

The pattern of variable changes is a vector that can be obtained using Equation 9,

rᵢ=x_{di}−x₀ᵢ (9)

where x_{di} is the value of variable i after detecting the abnormal situation, x₀ᵢ is the value of variable i before the abnormal situation and rᵢ is the difference between both values.

The vector r can be normalized using Equation 10 (Kramer, 1987).

$${Rn}_{i} = [ 1 - \frac{1}{1 + {( \frac{{r}_{i}}{{σ}_{i}} )}^{6}} ] sign ( {r}_{i} ) \qquad ( 10 )$$

where θᵢ is the standard deviation of variable i.

To finish the diagnostic step, the match between the current state pattern and all the patterns corresponding to faults included in the library is calculated. The match for each fault signature included in the library is quantified by the squared Euclidean distance between vector Rn and the corresponding fault pattern vectors, pₖ (Equation 11).

Dₖ=Σᵢ₌₀^{N}(Rnᵢpₖᵢ)² (11)

where N is the number of measured variables and k indicates a given fault in the library.

Once Dₖ is determined for all the fault patterns in the library, Equation 12 is used to calculate the likelihood Vₖ of each one. The fault with the highest likelihood is selected as the one that explains the ongoing abnormal situation.

$${V}_{k} = \frac{1}{1 + {D}_{k}} \qquad ( 12 )$$

As previously mentioned, x_{d} is the vector of process variables measured immediately after detecting a fault by means of a multivariate statistics. In order to use Equation 9, the vector x₀ (i.e., the vector corresponding to a normal state) has to be determined.

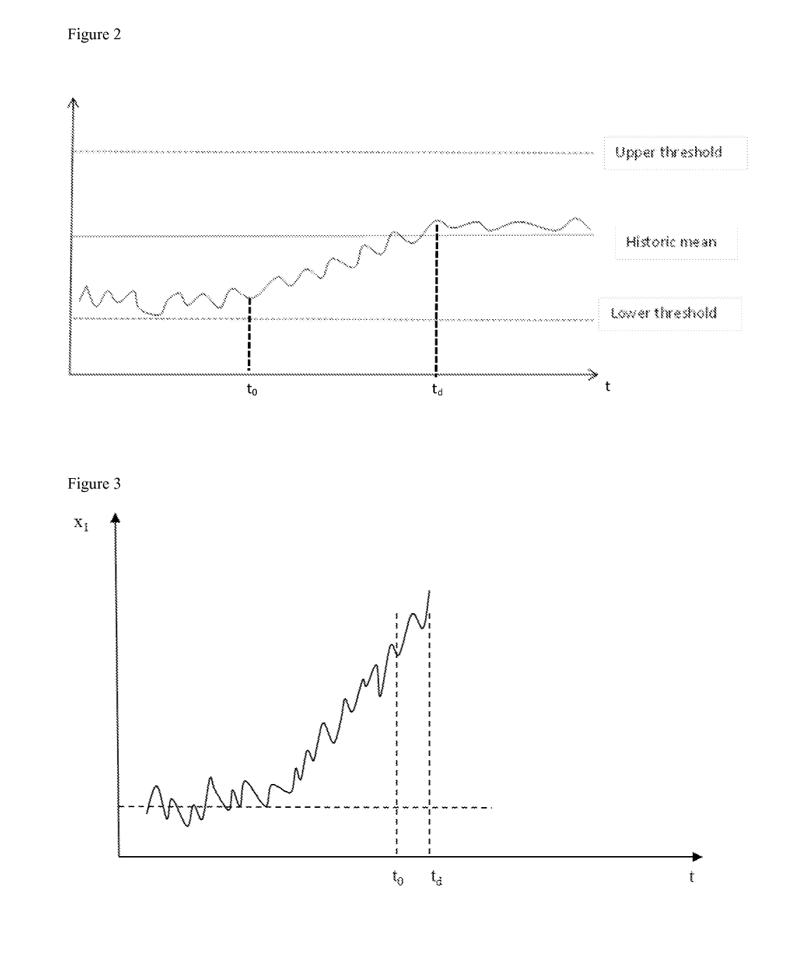

The simplest way of selecting x₀ is using the historic mean of the normal data. This choice can reduce the sensitivity of the method when one or more variables are at a normal but extreme condition before the fault starts. This effect is depicted in FIG. 2. In the figure, a monitored variable is circumstantially in the lower end of the normal range when the fault occurs at time t₀. The fault was detected at time t_{d} using deviations in variables not shown in the figure. In this case a fault that makes the shown variable increase leaves it close to the normal range mean. Then the use of the historic mean as a reference assigns a 0 to the state of the variable even if the correct sign is 1.

To improve the selection criteria it should be taken into account that the system can evolve from the normal to the abnormal situation in different time scales. Depending on the type of the problem, it can be necessary to compare the value of the variables after the detection with their values before a longer or shorter period of time.

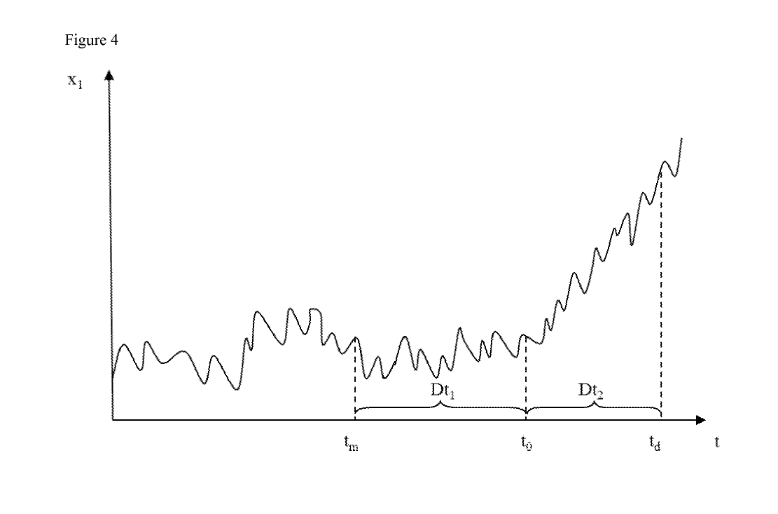

When the time lag for the comparison is too short, the calculated variable change rᵢ can be less than the real change. In FIG. 3 it can be seen that when the considered t₀ (corresponding to the last normal value) is too close to t_{d} (time of the fault detection), the calculated rᵢ is lower than the real change in the variable i, and it could be wrongly assigned a nil direction change. When the time lag for the comparison is too long, previous phenomena that do not represent the state of the process before the fault can be inadvertently included in the comparison. The present application solves all the above mentioned issues creating a local model of the system behavior.

The main contribution of the present application is a criterion to select t₀. For this purpose, a local model of the process behavior prior to the fault is built using any of the methods mentioned in the detection unit description. This model can include all the variables or different models can be calculated for groups of one or more variables. Models as simple as a local average and standard deviation can be used.

FIG. 4 shows the time period, Dt₁, during which the local model data is registered. This time period begins at tₘ and ends at t₀, when the abnormal situation starts. During Dt₂ the process evolves until the abnormal situation is detected at t_{d}.

As already mentioned when describing the detection unit, t_{d} is determined using a multivariate statistical method, which calculates an appropriate statistics for fault detection. The proposed criteria to determine tₘ and t₀ is that the value of the statistics for the local model in t₀ is less than or equal to the Jth percentile of such statistics for the period Dt₁, where J is a number greater than zero and smaller than 100, being 50 a good option.

Dt₂ is calculated from Dt₁ as follows: for each Dt₁, different values of t₀ are selected, in descending order, starting from the instant before t_{d}. Different local models are calculated using data between tₘ and each different t₀ until the corresponding statistics for t₀ are found to be lower than the Jth percentile. Then, Dt₂ is calculated as the difference between the chosen t₀ and t_{d}.

For each pair (Dt₁; Dt₂), a vector of standardized signs Rn is calculated. The actual Rn is selected as the one closest to the center of mass of all the calculated Rn. The reason for selecting this criterion is that when Dt₁ is too large, previous events begin to interfere with the local model and t₀ and Rn go away from the mass center. When Dt₁ is too small, local noise interferes and t₀ and Rn go away from the mass center. In the middle, there is a set of Dt₁ for which t₀ and Rn are almost the same because in all the cases the local model represents the same state of the process. This is the criteria behind the method for Rn selection.

When the process dynamics is well known, a fixed Dt₁ can be used as a parameter. In this case, the determination of Dt₂ is performed in the same way but only one Rn is calculated, accelerating the procedure. In other case the proposed method does not require the tuning of any parameter.

The aforesaid are merely preferred embodiments of the present application and should not be used to restrict the scope of the present application. It is understood that those skilled in the art may carry out changes and modifications to the described embodiments without departing from the content of the invention.

1. A device for diagnosing of anomalous situations in processes, equipment and sensors used to measure and control variables of a process, based on calculation of residuals between measured and calculated values for a plurality of models, the device comprising:
a data storage section that stores data;
a pre-processing section that filters said data;
a modeling section that generates and stores a normal process model for detection and a local process behavior model for diagnosis, the modeling unit allowing determining at what point the process shifts from a steady state prior to a fault to another steady state after the fault;
a residual calculating section that calculates difference between the measured value and a predicted value of variables and determines presence of a fault;
a calculation section that calculates a change trend and establishes a time reference point for comparing a value of each variable before and after the fault, detecting onset of a fault from a local model of system behavior and the time of fault with the process model based on historical data of normal operation, and with two points building two temporal reference points to determine the change trend of each variable;
an analysis section that analyzes, based on a distance between a vector representing current change trends after the fault to vectors corresponding to different known faults, which faults correspond with most probability to the current process situation and determining necessity or communicating an anomalous situation to the process operator; and
a displaying section that displays a process status report.

2. The device of claim 1, wherein on the basis of calculation of change trends of the measured variables and comparing the change trends to the trends corresponding to a set of faults, a report of status of the process is presented through a communication section, detecting if the process operation is normal or has faults, and diagnosing if a fault occurs after the detection carried out.

3. The device of claim 1, wherein the data storage section is a magnetic storage device.

4. The device of claim 1, wherein the pretreatment section filters the data by using moving median or simple averages.

5. The device of claim 1, wherein the pretreatment section normalize the data by using a historic mean and a standard deviation of each variable.

6. The device of claim 5, wherein the data is normalized using the following equation:
$${x}_{i} = ( \frac{{xm}_{i} - {μ}_{i}}{{σ}_{i}} )$$
where μᵢ is the historic mean, σᵢ is the standard deviation, and “i” is a variable.

7. The device of claim 1, wherein the modeling section uses principal component analysis (PCA) for generating the normal process model.

8. The device of claim 1, wherein a direction of the vector representing the change trends changes when one of a state in which the variable increases significantly due to the failure, a state in which the variable decreases significantly due to the failure, and a state in which the variable does not change significantly because of the failure, changes to another state.

9. The device of claim 1, wherein the normal process model is built on the basis of the historical data, and the local process behavior model is built from data obtained immediately before the fault.

10. A method for diagnosing anomalous situations in processes, equipment and sensors used to measure and control variables of the process, based on calculation of residuals between measured values and calculated values from a plurality of models, the method comprising:
storing data in a data storage section;
pre-processing said data by filtering the data;
generating and storing by a modeling section a normal process model for detection and a local process behavior model for diagnosis, and allowing determining at what point a steady state prior to the fault is shifted to another steady state after the fault;
detecting presence of a failure using a global model;
calculating a change trend and establishing a time reference point for comparing a value of each variable before and after the fault, detecting onset of the fault from a local model of system behavior and the time of fault with the process model based on historical data of the normal process operation, and with two points building two temporal reference points to determine the change trend of each variable;
analyzing and determining, based on a distance between a vector representing current change trends after the fault to vectors corresponding to different known faults, which faults correspond with most probability to the current process situation and determining necessity or communicating an anomalous situation to the process operator; and
displaying a process status report on a displaying section.

11. The method of claim 10, wherein on the basis of calculation of change trends of the measured variables and comparing the change trends to the trends corresponding to a set of faults, a report of status of the process is presented through a communication section, detecting if the process operation is normal or has faults, and diagnosing if a fault occurs after the detection carried out.

12. The method of claim 10, wherein the data storage section is a magnetic storage device.

13. The method of claim 10, wherein the data is filtered by using moving median or simple averages.

14. The method of claim 10, wherein the pretreatment unit normalize the data by using a historic mean and a standard deviation of each variable.

15. The method of claim 14, wherein the data is normalized using the following equation:
$${x}_{i} = ( \frac{{xm}_{i} - {μ}_{i}}{{σ}_{i}} )$$
where μᵢ is the historic mean, σᵢ is the standard deviation, and “i” is a variable.

16. The method of claim 10, wherein principal component analysis (PCA) is used for generating the normal process model.

17. The method of claim 10, wherein a direction of the vector representing the change trends changes when one of a state in which the variable increases significantly due to the failure, a state in which the variable decreases significantly due to the failure, and a state in which the variable does not change significantly because of the failure, changes to another state.

18. The device of claim 10, wherein the normal process model is built on the basis of the historical data, and the local process behavior model is built from data obtained immediately before the fault.

19. A device for diagnosing of anomalous situations in processes, equipment and sensors used to measure and control variables of a process, based on calculation of residuals between measured and calculated values for a plurality of models, the device comprising:
a pretreatment unit that receives measured variables and filters data;
a data storage unit that stores the data;
a modeling unit that generates and stores a normal process model for detection and a local process behavior model for diagnosis based on a historic data set;
a detection unit that calculates difference between the measured value and a predicted value of variables and determines presence of a fault;
a diagnosis unit that performs diagnosis and determines a fault by comparing change trends of measured variables, and that determines an anomalous situation based on a distance between a vector representing current change trends after the fault to vectors corresponding to different known faults; and
a display that displays an indication of the anomalous state based on the determination by the diagnosis unit.
